(19) United States
(12) Patent Application Publication
(10) Pub. No.: US 2025/0310432 A1
(43) Pub. Date: Oct. 2, 2025

(54) MOBILE PHONE CASE CONVENIENT FOR TAKING SELFIES

(71) Applicant: Jingdong (Guangzhou) Electronics Co., Ltd., Guangzhou (CN)

(72) Inventor: Jingdong XIONG, Shiyan (CN)

(73) Assignee: Jingdong (Guangzhou) Electronics Co., Ltd., Guangzhou (CN)

(21) Appl. No.: 18/632,092

(22) Filed: Apr. 10, 2024

(30) Foreign Application Priority Data
Mar. 26, 2024 (CN) 2024206000324

(51) Int. Cl. H04M 1/72409; H04M 1/72412; H04M 1/72466

(52) U.S. Cl. CPC H04M 1/724092; H04M 1/72412; H04M 1/72466; H04M 2250/52

(57) ABSTRACT

The present invention relates to the technical field of mobile phone cases, and in particular to a mobile phone case convenient for taking selfies. The mobile phone case includes: a mobile phone case body, where the mobile phone case body is used for covering side surfaces and a back surface of a mobile phone; a screen projection display module, wherein the screen projection display module is mounted at a rear end of the mobile phone case body; and a screen projection receiving module, where the screen projection receiving module is in communication connection with the mobile phone, and also in communication connection with the screen projection display module, and the screen projection receiving module acquires screen projection data of the mobile phone and sends the screen projection data to the screen projection display module for display.

### CROSS-REFERENCE TO RELATED APPLICATIONS

The application claims priority to Chinese patent application No. 2024206000324, filed on Mar. 26, 2024, the entire contents of which are incorporated herein by reference.

### TECHNICAL FIELD

The present invention relates to the technical field of mobile phone cases, and in particular to a mobile phone case convenient for taking selfies.

### BACKGROUND

With the development and popularization of a photographing technology and functions of a mobile phone, photographing with the mobile phone has become one of the most important functions of the mobile phone and is gradually replacing cameras. It has been used in more and more life scenes, serving as a convenient tool for people to record their lives. For the convenience of taking selfies, most mobile phones on the market have front selfie camera, but as well known, shooting effects of the front cameras of most mobile phones are far worse than that of a rear camera, and the front camera with a poor imaging ability can not meet the requirements of high quality photography.

Chinese invention patent with an application No. 201720615125.4 discloses an integrated selfie mobile phone case with a selfie lens, which includes a mobile phone case body that can be fixed to a mobile phone, where a selfie button is disposed at a side or a back surface of the mobile phone case body, the selfie button is connected with a Bluetooth selfie controller, and a reflective mirror is disposed at the back surface of the mobile phone case body. When a user takes selfies by turning the mobile phone around, the mirror on the back surface of the mobile phone case body can reflect a scene in front as a reference interface for shooting content, and the user can take selfies just like using a front camera of an ordinary mobile phone, which is convenient and simple to use. Although the patent can take selfies with the rear camera, a display effect of the mirror is poor, and it is easily affected by the cleanliness and an observation angle of the mirror.

### SUMMARY

In order to overcome the defects in the prior art, the present invention aims to provide a mobile phone case convenient for taking selfies.

A purpose of the present invention is achieved by the following technical solution. There is provide a mobile phone case convenient for taking selfies, the mobile phone case including:
a mobile phone case body, wherein the mobile phone case body is used for covering side surfaces and a back surface of a mobile phone;
a screen projection display module, wherein the screen projection display module is mounted at a rear end of the mobile phone case body; and
a screen projection receiving module, wherein the screen projection receiving module is in communication connection with the mobile phone, and also in communication connection with the screen projection display module, and the screen projection receiving module acquires screen projection data of the mobile phone and sends the screen projection data to the screen projection display module for display.

Preferably, the screen projection display module includes a control panel and a display screen, the control panel is electrically connected with the display screen, the screen projection receiving module is integrated on the control panel, the screen projection receiving module is electrically connected with the control panel, wherein the screen projection receiving module acquires the screen projection data of the mobile phone, sends the screen projection data to the control panel for processing and then displays the processed screen projection data on the display screen.

Preferably, the control panel includes a communication interface, and the screen projection receiving module is connected with the mobile phone through the communication interface.

Preferably, the control panel includes a wireless module, and the screen projection receiving module is in communication connection with the mobile phone through the wireless module.

Preferably, the control panel further includes a power supply module and the power supply module is used for supplying power to at least the screen projection receiving module.

Preferably, the mobile phone case body is provided with a control key, and the control key is used for controlling a working state of the screen projection receiving module.

Preferably, the control panel further includes a main control module, one end of the main control module is connected with the power supply module, the other end of the main control module is connected with the screen projection receiving module through the control key, and the main control module is used for controlling the working state of the screen projection receiving module through the control key.

Preferably, the screen projection receiving module is further used for receiving a reverse control instruction returned by the control panel and feeding the reverse control instruction back to the mobile phone, so as to reversely control the mobile phone.

Preferably, the mobile phone case body includes a frame and a rear cover, the frame is used for covering the side surfaces of the mobile phone, the rear cover is used for covering the back surface of the mobile phone, and a rear end of the frame is detachably connected with a front end of the rear cover.

Preferably, the display screen is embedded into a lower middle part of the rear end of the rear cover, the control panel is fixed in the rear cover, and a front end surface of the control panel is covered with a cover plate and a sticker sequentially.

The present invention has the beneficial effects that according to the mobile phone case of the present invention, with the adoption of the screen projection display module and the screen projection receiving module, the screen projection receiving module can receive the screen projection data sent by the mobile phone and then send it to the screen projection display module for display, that is, a shooting interface of the mobile phone can be displayed through the screen projection display module, so that it is convenient for a user to take selfies or livestream with a rear camera of the mobile phone; the display is clear, so that the user can obtain a best shooting experience; and the mobile phone case is simple in structure and convenient to use.

### BRIEF DESCRIPTION OF DRAWINGS

FIG. 1 is a perspective view of a first embodiment of the present invention.

FIG. 2 is a usage state diagram of the first embodiment of the present invention.

FIG. 3 is a perspective exploded view of the first embodiment of the present invention.

FIG. 4 is a structural schematic diagram of the first embodiment of the present invention.

FIG. 5 is a structural schematic diagram of a second embodiment of the present invention.

FIG. 6 is a structural schematic diagram of a third embodiment of the present invention.

### REFERENCE NUMERALS

mobile phone 10; mobile phone case body 1; control key 11; frame 12; slot 121; rear cover 13; inserting block 131; camera hole 132; key hole 133; through hole 134; cover plate 14; sticker 15; screen projection display module 2; screen projection receiving module 20; control panel 21; communication interface 23; connecting wire 212; display screen 22; communication interface 23; wireless module 24; power supply module 25; power supply interface 26; main control module 27.

### DETAILED DESCRIPTION OF THE EMBODIMENTS

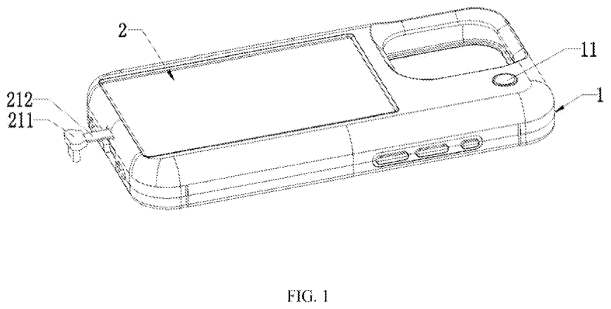

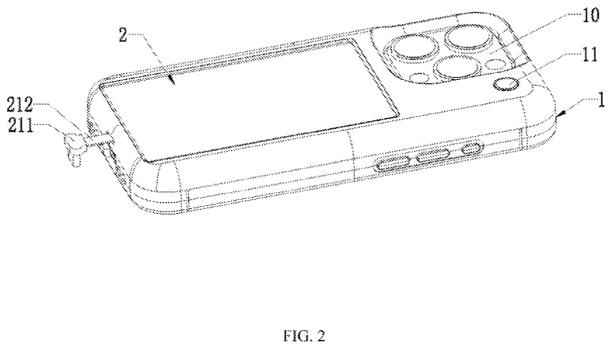

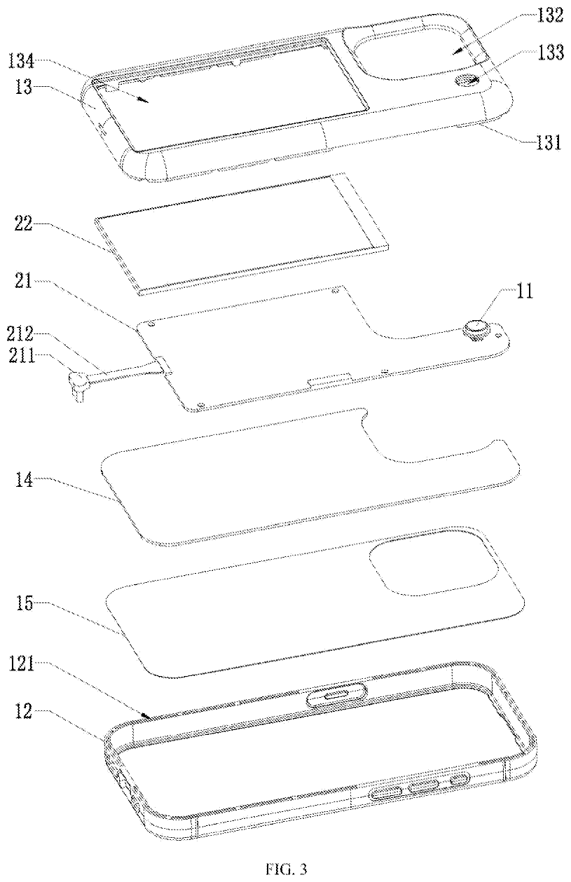

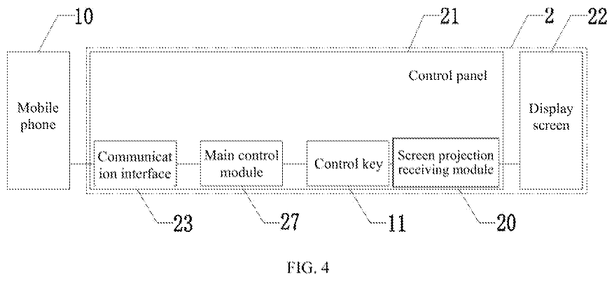

In order to facilitate the understanding of those skilled in the art, the present invention will be further explained with reference to embodiments and FIGS. 1-6, and reference to the embodiments is not intended to limit the present invention.

As shown in FIGS. 1-4, which show a first embodiment of a mobile phone case convenient for taking selfies according to the present invention. The mobile phone case includes:
a mobile phone case body 1, wherein the mobile phone case body 1 is used for covering side surfaces and a back surface of a mobile phone 10;
a screen projection display module 2, wherein the screen projection display module 2 is mounted at a rear end of the mobile phone case body 1; and
a screen projection receiving module 20, wherein the screen projection receiving module 20 is in communication connection with the mobile phone 10, the screen projection receiving module 20 is also in communication connection with the screen projection display module 2, and the screen projection receiving module 20 acquires screen projection data of the mobile phone 10 and sends the screen projection data to the screen projection display module 2 for display. The communication connection in this embodiment includes wired connection and wireless connection.

According to the mobile phone 10 case of the present invention, with the adoption of the screen projection display module 2 and the screen projection receiving module 20, the screen projection receiving module 20 can receive the screen projection data sent by the mobile phone 10 and then send it to the screen projection display module 2 for display, that is, a shooting interface of the mobile phone 10 can be displayed through the screen projection display module 2, so that it is convenient for a user to take selfies or livestream with a rear camera of the mobile phone 10; the display is clear, so that the user can obtain a best shooting experience; and the mobile phone case is simple in structure and convenient to use.

In this embodiment, the screen projection display module 2 includes a control panel 21 and a display panel 22, the control panel 21 is electrically connected with the display screen 22, the screen projection receiving module 20 is integrated on the control panel 21, the screen projection receiving module 20 is electrically connected with the control panel 21, wherein the screen projection receiving module 20 acquires the screen projection data of the mobile phone 10, sends the screen projection data to the control panel 21 for processing, and then displays the processed screen projection data on the display panel 22. The screen projection data can be picture data and/or sound data, and the control panel 21 is used for receiving and decoding the picture data and/or the sound data, and displaying on the display screen 22. In this embodiment, the screen projection receiving module 20 is connected with the display screen 22.

In this embodiment, the control panel 21 includes a communication interface 23, and the screen projection receiving module 20 is connected with the mobile phone 10 through the communication interface 23. Specifically, the communication interface 23 is connected with the control panel 21 through a connecting wire 212, and the communication interface 23 may be a Lighting interface or a Type-C interface, a two-in-one interface supporting Lighting or Type-C, or a three-in-one interface supporting Lighting, Type-A and Type-C. In this embodiment, the power supply module 25 may not be used, and the mobile phone 10 may directly provide power for the screen projection receiving module 20 through the communication interface 23, so that the screen projection receiving module 20 can perform a normal screen projection operation flow.

In this embodiment, the mobile phone case body 1 is provided with a control key 11, and the control key 11 is used for controlling a working state of the screen projection receiving module 20. The user can directly operate to set a screen projection wallpaper and control the start, pause and close of screen projection according to a triggering state of the control key 11.

In this embodiment, the control panel 21 further includes a main control module 27, one end of the main control module 27 is connected with the power supply module 25, the other end of the main control module is connected with the screen projection receiving module 20 through the control key 11, and the main control module 27 is used for controlling the working state of the screen projection receiving module 20 through the control key 11. The control key 11 may be a combination of a screen projection start key, a screen projection end key, a screen projection pause key, up, down, left and right keys, etc. For example, if the control key 11 is the screen projection start key, the main control module 27 is used for controlling the screen projection receiving module 20 to receive screen projection data of the mobile phone 10 after it is detected that the screen projection start key is triggered, and sending the screen projection data to the screen projection display module 2 for display. Moreover, because the power supply module 25 is connected with the main control module 27, the power supply module 25 can supply power to the main control module 27, such that the main control module 27 can perform a corresponding screen projection operation.

In this embodiment, the screen projection receiving module 20 is further used for receiving a reverse control instruction returned by the control panel 21, and feeding the reverse control instruction back to the mobile phone 10, so as to reversely control the mobile phone 10. The screen projection display module 2 will send the reverse control instruction to the screen projection receiving module 20, the screen projection receiving module 20 receives the reverse control instruction from the screen projection display module 2 and send the reverse control instruction to the mobile phone 10 to reversely control running of the mobile phone 10. For example, the user can operate an APP on the mobile phone 10 through the screen projection display module 2, so that the interestingness of screen projection is improved and the operation of the user is facilitated.

In this embodiment, the display screen 22 is an LCD display screen, an LED display screen or an OLED display screen. The display screen 22 may be a touch screen, so that the user can reversely control the APP on the mobile phone 10 by touching the display screen.

In this embodiment, the mobile phone case body 1 includes a frame 12 and a rear cover 13, the frame 12 is used for covering the side surfaces of the mobile phone 10, the rear cover 13 is used for covering the back surface of the mobile phone 10, and a rear end of the frame 12 is detachably connected with a front end of the rear cover 13. Specifically, a plurality of slots 121 are formed in the rear end of the frame 12, and inserting blocks 131 are convexly disposed at positions, corresponding to the slots 121 one by one, of the front end of the rear cover 13, each inserting block 131 is inserted into the corresponding slot 121. The above structure is convenient for disassembly and replacement. In other embodiments, the frame 12 and the rear cover 13 may be integrally formed.

In this embodiment, the display screen 22 is embedded into a lower middle part of the rear end of the rear cover 13, the control panel 21 is fixed in the rear cover 13, and a front end surface of the control panel 21 is covered with a cover plate 14 and a sticker 15 sequentially. Specifically, a camera hole 132 is formed in an upper left side of the rear end of the rear cover 13, the upper right side of the rear cover 13 is provided with a key hole 133, the control key 11 is embedded into the key hole 133, a through hole 134 is formed in the lower middle part of the rear cover 13, and the display screen 22 is embedded into the through hole 134. The above structure is convenient for the levelness of an inner side of the rear cover.

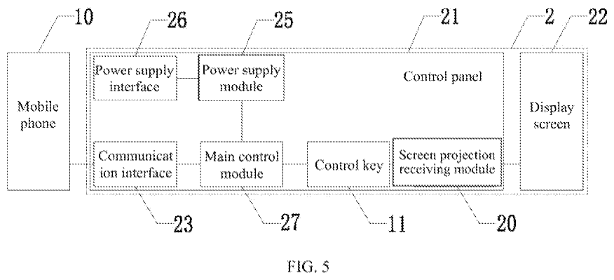

As shown in FIG. 5, a second embodiment of a mobile phone case convenient for taking selfies according to the present invention is provided, which is different from the above-mentioned first embodiment in that the control panel 21 further includes a power supply module 25, and the power supply module 25 is used for supplying power to at least the screen projection receiving module 20. With the adoption of the power supply module 25 (such as a lithium battery), power can be supplied to the screen projection receiving module 20, and the power supply module can also be used to supply power to the mobile phone 10; the power supply module 25 may be a charging IC module, and the charging IC module may be a lithium battery; when the mobile phone 10 is connected with the screen projection receiving module 20, it can supply power to other modules of the control panel 21 through the charging IC module, and it can also supply power to the mobile phone 10. In some embodiments, the rear cover is also provided with a power supply interface 26, the power supply interface 26 is connected with the power supply module 25, the power supply module 25 is connected with an external power supply through the power supply interface 26, and/or the power supply module 25 stores electric energy of the external power supply through the power supply interface 26. Moreover, in some embodiments, the power supply interface 26 can be the Type-C interface, and is connected with a charging head through a connecting wire of a charger to charge the power supply module 25, so that the power supply module 25 has enough electric energy to power the screen projection receiving module 20 itself and/or charge the mobile phone 10, and a screen projection operation can be performed normally.

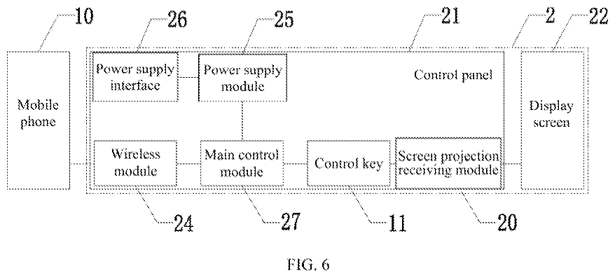

As shown in FIG. 6, a third embodiment of a mobile phone case convenient for taking selfies according to the present invention is provided, which is different from the above-mentioned second embodiment in that the control panel 21 includes a wireless module 24, and the screen projection receiving module 20 is in communication connection with the mobile phone 10 through the wireless module 24. The wireless module 24 includes a WIFI module and/or a Bluetooth module, the main control module includes a DP protocol IC module and/or a USB HUB IC module, and the main control module may further include an Apple communication protocol IC module. The Bluetooth module can reversely control the mobile phone 10 by Bluetooth, and can also be used for receiving screen projection data sent by the mobile phone 10 and send the screen projection data to the screen projection display module 2. A model of the WIFI module may be a Realek's RTL8821WIFI chip, which can transmit picture data and sound data simultaneously. The USB HUB IC module can realize a function of reversely controlling the mobile phone 10. The DP protocol IC module can support the mobile phone 10 of a DP protocol, and when the mobile phone 10 is a mobile phone 10 supporting the DP protocol, can directly acquire screen projection data of the mobile phone 10.

The above-mentioned embodiments are preferred implementations of the present invention. Besides, the present invention can be implemented in other ways, and any obvious substitutions are within the protection scope of the present invention without departing from the concept thereof.

What is claimed is:

1. A mobile phone case convenient for taking selfies, wherein the mobile phone case comprises:
a mobile phone case body, wherein the mobile phone case body is used for covering side surfaces and a back surface of a mobile phone;
a screen projection display module, wherein the screen projection display module is mounted at a rear end of the mobile phone case body; and
a screen projection receiving module, wherein the screen projection receiving module is in communication connection with the mobile phone, and also in communication connection with the screen projection display module, and the screen projection receiving module acquires screen projection data of the mobile phone and sends the screen projection data to the screen projection display module for display.

2. The mobile phone case convenient for taking selfies according to claim 1, wherein the screen projection display module comprises a control panel and a display screen, the control panel is electrically connected with the display screen, the screen projection receiving module is integrated on the control panel, the screen projection receiving module is electrically connected with the control panel, wherein the screen projection receiving module acquires the screen projection data of the mobile phone, sends the screen projection data to the control panel for processing and then displays the processed screen projection data on the display screen.

3. The mobile phone case convenient for taking selfies according to claim 2, wherein the control panel comprises a communication interface, and the screen projection receiving module is connected with the mobile phone through the communication interface.

4. The mobile phone case convenient for taking selfies according to claim 2, wherein the control panel comprises a wireless module, and the screen projection receiving module is in communication connection with the mobile phone through the wireless module.

5. The mobile phone case convenient for taking selfies according to claim 2, wherein the control panel further comprises a power supply module and the power supply module is used for supplying power to at least the screen projection receiving module.

6. The mobile phone case convenient for taking selfies according to claim 2, wherein the mobile phone case body is provided with a control key, and the control key is used for controlling a working state of the screen projection receiving module.

7. The mobile phone case convenient for taking selfies according to claim 6, wherein the control panel further comprises a main control module, one end of the main control module is connected with the power supply module, the other end of the main control module is connected with the screen projection receiving module through the control key, and the main control module is used for controlling the working state of the screen projection receiving module through the control key.

8. The mobile phone case convenient for taking selfies according to claim 2, wherein the screen projection receiving module is further used for receiving a reverse control instruction returned by the control panel and feeding the reverse control instruction back to the mobile phone, so as to reversely control the mobile phone.

9. The mobile phone case convenient for taking selfies according to claim 2, wherein the mobile phone case body comprises a frame and a rear cover, the frame is used for covering the side surfaces of the mobile phone, the rear cover is used for covering the back surface of the mobile phone, and a rear end of the frame is detachably connected with a front end of the rear cover.

10. The mobile phone case convenient for taking selfies according to claim 9, wherein the display screen is embedded into a lower middle part of the rear end of the rear cover, the control panel is fixed in the rear cover, and a front end surface of the control panel is covered with a cover plate and a sticker sequentially.
